(19) United States
(12) Patent Application Publication
(10) Pub. No.: US 2013/0063564 A1
(43) Pub. Date: Mar. 14, 2013

(54) IMAGE PROCESSOR, IMAGE PROCESSING METHOD AND PROGRAM

(71) Applicants: Nobuhiro Saijo, Tokyo (JP); Shingo Tsurumi, Saitama (JP)

(72) Inventors: Nobuhiro Saijo, Tokyo (JP); Shingo Tsurumi, Saitama (JP)

(73) Assignee: Sony Corporation, Tokyo (JP)

(21) Appl. No.: 13/599,001

(22) Filed: Aug. 30, 2012

(30) Foreign Application Priority Data
Sep. 12, 2011 (JP) 2011-197793

(51) Int. Cl. H04N 13/02

(52) U.S. Cl. 348/46; 348/E13.074

(57) ABSTRACT

Disclosed herein is an image processor including: a first emission section for emitting light at a first wavelength to a subject; a second emission section for emitting light at a second wavelength longer than the first wavelength to the subject; an imaging section for capturing an image of the subject; a detection section for detecting a body region representing at least one of the skin and eyes of the subject based on a first captured image acquired by image capture at the time of emission of the light at the first wavelength and a second captured image acquired by image capture at the time of emission of the light at the second wavelength; a calculation section for calculating viewpoint information; and a display control section for controlling a display mechanism adapted to allow the subject to visually recognize an image as a stereoscopic image.

### BACKGROUND

The present disclosure relates to an image processor, image processing method and program, and more particularly, to an image processor, image processing method and program for allowing visual recognition of an image on a display as a stereoscopic image irrespective of where the display is visually recognized.

There are 3D techniques based, for example, on the parallax barrier and lenticular lens approaches, that allow visual recognition of an image on a display as a stereoscopic image without the viewer wearing any 3D goggles (refer, for example, to Japanese Patent Laid-Open No. 2005-250167).

Here, the image on the display is made up of two-dimensional images for left and right eyes. Further, there is a parallax between the two-dimensional images for left and right eyes so that an object in the image visually recognized by the viewer appears stereoscopic.

It should be noted that the term “parallax” refers, for example, to the displacement between the object in the two-dimensional image for left eye and that in the two-dimensional image for right eye. The larger this displacement, the more to the front as seen from the viewer the object is visually recognized as stereoscopic.

When an image on a display is presented to the viewer, the above 3D techniques ensure, for example, that the two-dimensional image for left eye is visually recognized only by the left eye of the viewer and that the two-dimensional image for right eye is visually recognized only by the right eye thereof.

### SUMMARY

Incidentally, the above 3D techniques assume that the viewer looks toward the front at the display screen from a position on the normal passing near the center of the display screen adapted to display an image.

Therefore, if, for example, the viewer looks diagonally at the display screen from a leftward or rightward position relative to the frontward position of the display screen, it is difficult for the viewer to visually recognize the image on the display screen as a stereoscopic image. Moreover, it is likely that pseudoscopy, i.e., visual recognition of a two-dimensional image for left eye by the right eye of the viewer and that of a two-dimensional image for right eye by the left eye thereof, may occur. Pseudoscopy, if it occurs, may cause discomfort to the viewer.

In light of the foregoing, it is desirable to allow visual recognition of an image on a display as a stereoscopic image irrespective of where the display is visually recognized.

An image processor according to a mode of the present disclosure includes: a first emission section configured to emit light at a first wavelength to a subject; a second emission section configured to emit light at a second wavelength longer than the first wavelength to the subject; an imaging section configured to capture an image of the subject; a detection section configured to detect a body region representing at least one of the skin and eyes of the subject based on a first captured image acquired by image capture at the time of emission of the light at the first wavelength and a second captured image acquired by image capture at the time of emission of the light at the second wavelength; a calculation section configured to calculate viewpoint information relating to the viewpoint of the subject from a calculation region including at least the detected body region; and a display control section configured to control a display mechanism adapted to allow the subject to visually recognize an image as a stereoscopic image according to the viewpoint information.

The calculation section can include a feature quantity calculation section configured to calculate, from the calculation region, a feature quantity representing the feature of a predetermined body region of all the body regions of the subject; and a viewpoint information calculation section configured to calculate the viewpoint information from the calculated feature quantity by referring to a storage section adapted to store, in advance, candidates for the viewpoint information in correlation with one of the feature quantities that are different from one another.

The feature quantity calculation section can calculate a feature quantity representing a feature of the subject's face from the calculation region including at least the body region representing the subject's skin.

The feature quantity calculation section can calculate a feature quantity representing a feature of the subject's eyes from the calculation region including at least the body region representing the subject's eyes.

The calculation section can calculate, from the calculation region, the viewpoint information including at least one of the direction of the subject's line of sight, the position of the subject's right eye, the position of the subject's left eye and the position of the subject's face.

The display control section can control the display mechanism to display a two-dimensional image for right eye at a position where the image can be visually recognized only by the right eye from the subject's line of sight and a two-dimensional image for left eye at a position where the image can be visually recognized only by the left eye from the subject's line of sight.

The display control section can control the display mechanism to separate a two-dimensional image for right eye that can be visually recognized only by the right eye from the subject's line of sight and a two-dimensional image for left eye that can be visually recognized only by the left eye from the subject's line of sight from a display screen operable to display the two-dimensional images for right and left eyes.

The display mechanism can be a parallax barrier or lenticular lens.

The first wavelength λ1 can be equal to or greater than 640 nm and equal to or smaller than 1000 nm, and the second wavelength λ2 equal to or greater than 900 nm and equal to or smaller than 1100 nm.

The first emission section can emit invisible light at the first wavelength λ1, and the second emission section can emit invisible light at the second wavelength λ2.

The imaging section can have a visible light cutting filter adapted to block visible light falling on the imaging section.

An image processing method according to another mode of the present disclosure is an image processing method of an image processor including a first emission section configured to emit light at a first wavelength to a subject, a second emission section configured to emit light at a second wavelength longer than the first wavelength to the subject, and an imaging section configured to capture an image of the subject, the image processing method including: detecting a body region representing at least one of the skin and eyes of the subject based on a first captured image acquired by image capture at the time of emission of the light at the first wavelength and a second captured image acquired by image capture at the time of emission of the light at the second wavelength; calculating viewpoint information relating to the viewpoint of the subject from a calculation region including at least the detected body region; and controlling a display mechanism adapted to allow the subject to visually recognize an image as a stereoscopic image according to the viewpoint information.

A program according to still another mode of the present disclosure is a program allowing a computer of an image processor to serve as a detection section, calculation section and display control section, the image processor including: a first emission section configured to emit light at a first wavelength to a subject; a second emission section configured to emit light at a second wavelength longer than the first wavelength to the subject; and an imaging section configured to capture an image of the subject, the detection section detecting a body region representing at least one of the skin and eyes of the subject based on a first captured image acquired by image capture at the time of emission of the light at the first wavelength and a second captured image acquired by image capture at the time of emission of the light at the second wavelength, the calculation section calculating viewpoint information relating to the viewpoint of the subject from a calculation region including at least the detected body region, and the display control section controlling a display mechanism adapted to allow the subject to visually recognize an image as a stereoscopic image according to the viewpoint information.

The present disclosure detects a body region representing at least one of the skin and eyes of the subject, calculates viewpoint information relating to the viewpoint of the subject from a calculation region including at least the detected body region, and controls a display mechanism adapted to allow the subject to visually recognize an image as a stereoscopic image.

The present disclosure allows visual recognition of an image on a display as a stereoscopic image irrespective of where the display is visually recognized.

### BRIEF DESCRIPTION OF THE DRAWINGS

FIG. 1 is a block diagram illustrating a configuration example of an image processor according to an embodiment of the present disclosure;

FIG. 2 is a diagram illustrating an example of a smallest rectangular region including a skin region of a viewer in a captured image;

FIG. 3 is a diagram illustrating an example of changing the display positions of two-dimensional images for left and right eyes respectively according to the positions of the eyeballs;

FIG. 4 is a diagram illustrating another example of changing the display positions of two-dimensional images for left and right eyes respectively according to the positions of the eyeballs;

FIG. 5 is a diagram illustrating spectral reflection characteristic on human skin;

FIG. 6 is a flowchart for describing a 3D control process performed by an image processor;

FIG. 7 is a diagram illustrating spectral reflection characteristic on human eyes;

FIG. 8 is a diagram illustrating examples of positions where pseudoscopy occurs and does not occur;

FIG. 9 is a diagram illustrating an example of display on an LCD (liquid crystal display); and

FIG. 10 is a block diagram illustrating a configuration example of a computer.

### DETAILED DESCRIPTION OF THE PREFERRED EMBODIMENT

A description will be given below of the preferred embodiment of the present disclosure (hereinafter referred to as the present embodiment). It should be noted that the description will be given in the following order.

### 1. Present Embodiment (Example in which an Image can be Visually Recognized as a Stereoscopic Image from any Viewpoint)

### 2. Modification Example

### 1. Present Embodiment

### [Configuration Example of Image Processor 21]

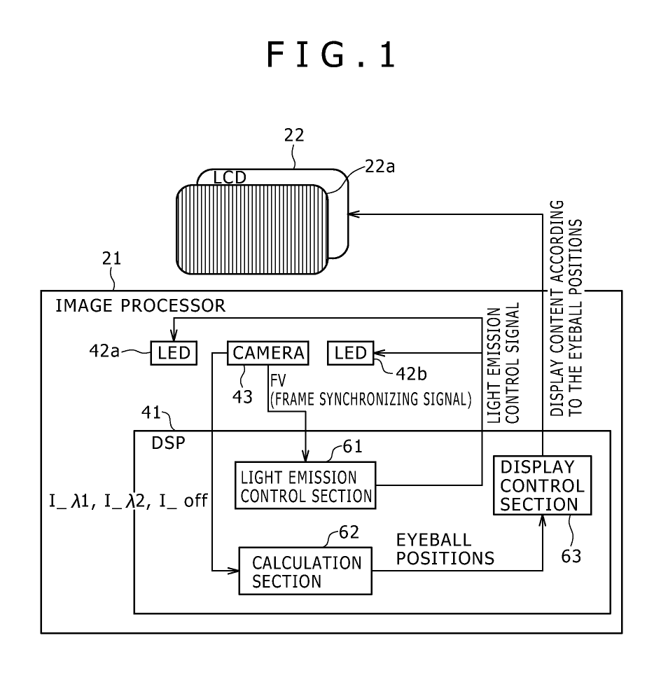

FIG. 1 is a block diagram illustrating a configuration example of an image processor 21 according to the present embodiment.

It should be noted that the image processor 21 allows an image on an LCD (liquid crystal display) 22 to be visually recognized as a stereoscopic image from any viewpoint irrespective of the viewpoint of the viewer viewing the image.

That is, for example, the image processor 21 captures an image of the viewer and calculates viewpoint information of the viewer from the captured image. Then, the image processor 21 changes content to be displayed on the LCD 22 according to the calculated viewpoint information, thus allowing the image to be visually recognized as a stereoscopic image from any viewpoint.

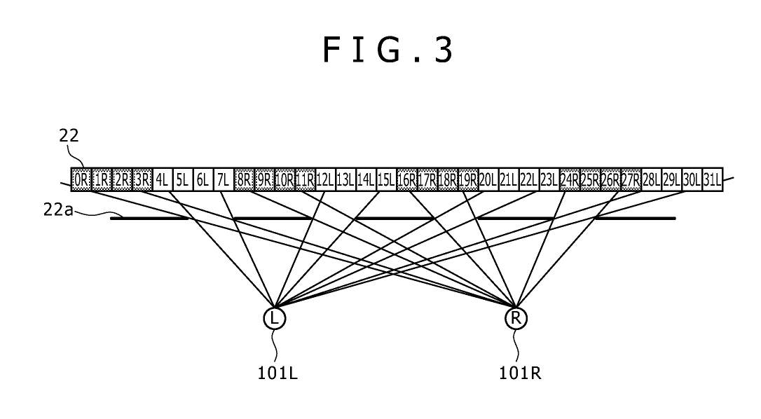

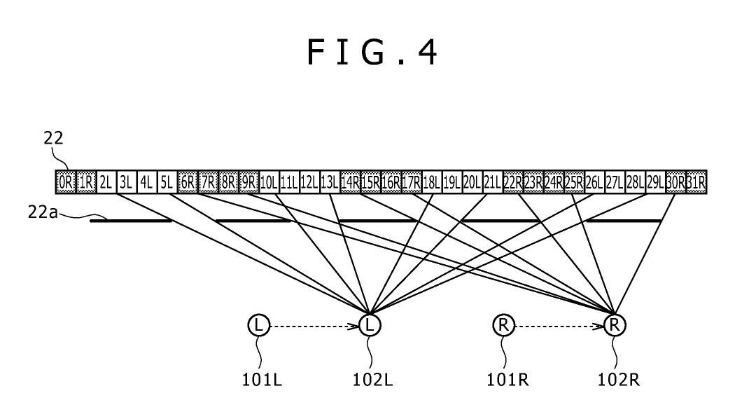

Here, the term “viewpoint information” refers to information relating to the viewpoint of the viewer which includes, for example, one of the direction of the viewer's line of sight, the position of the viewer's right eye, the position of the viewer's left eye and the position of the viewer's face. That is, viewpoint information can be any kind of information so long as the positional relationship between the LCD 22 and the viewer's viewpoint (positional relationship shown in FIGS. 3 and 4 which will be described later) can be determined. For example, therefore, not only positions in the captured image but also those in a real space (actual space) can be used as the positions of the left and right eyes and face of the viewer.

In the present embodiment, the image processor 21 calculates viewpoint information including the positions of the viewer's right and left eyes from a captured image, thus changing content to be displayed on the LCD 22 according to the calculated viewpoint information.

Further, the LCD 22 has a parallax barrier 22a on its front surface so that an image displayed on the LCD 22 is visually recognized as a stereoscopic image. The parallax barrier 22a includes, for example, a polarizing plate or switching liquid crystal to block part of light of the image displayed on the LCD 22 and pass the rest, optically separating two-dimensional images for right and left eyes.

It should be noted that a lenticular lens may be used rather than the parallax barrier 22a. The lenticular lens optically separates two-dimensional images for right and left eyes by changing the direction in which light of the image displayed on the LCD 22 is emitted.

The image processor 21 includes a DSP (digital signal processor) 41, LED (light-emitting diode) 42a, LED 42b and camera 43. It should be noted that the number of the LEDs 42a and that of the LEDs 42b are not necessarily one. Instead, there are two or more thereof as necessary.

The DSP 41 serves as a light emission control section 61, calculation section 62 and display control section 63, for example, if the control program stored in a memory not shown is executed.

The light emission control section 61 controls the LEDs 42a and 42b to light up and go out based on a frame synchronizing signal from the camera 43. Here, the frame synchronizing signal indicates when an image is captured by the camera 43.

That is, for example, the light emission control section 61 repeats a sequence of lighting up only the LED 42a, lighting up only the LED 42b and keeping both the LEDs 42a and 42b unlit each time an image is captured by the camera 43.

The calculation section 62 acquires captured images I_λ1, I_λ2 and I_off from the camera 43. Here, the term “captured image I_λ1” refers to an image captured by the camera 43 when only the LED 42a adapted to emit light at the wavelength λ1 is lit.

On the other hand, the term “captured image I_λ2” refers to an image captured by the camera 43 when only the LED 42b adapted to emit light at the wavelength λ2 is lit. Still further, the term “captured image I_off” refers to an image captured by the camera 43 when both the LEDs 42a and 42b are unlit.

The calculation section 62 smoothes each of the acquired captured images I_λ1, I_λ2 and I_off using an LPF (low-pass filter). Further, the calculation section 62 calculates a difference (Y(λ1)−Y(λ2)) for each pixel by subtracting a luminance level Y(λ2) of the captured image I_λ2 from a luminance level Y(λ1) of the captured image I_λ1.

Still further, the calculation section 62 normalizes (divides) the difference (Y(λ1)−Y(λ2)) with a luminance level (Y(λ1)−Y(off)), for example. It should be noted that the luminance level Y(off) represents the luminance level of the captured image I_off.

Then, the calculation section 62 binarizes a difference image I_diff (={(I_λ1−I_λ2)/(I_λ1−I_off)}×100) with a predetermined binarization threshold, thus calculating a binarized skin image I_skin. The difference image I_diff is acquired by multiplying the normalized difference {(Y(λ1)−Y(λ2))/(Y(λ1)−Y(off))} by a predetermined value (e.g., 100).

It should be noted that the difference image I_diff (={(I_λ1−I_λ2)/(I_λ1−I_off)}×100) shows by how many percentage points the luminance level of the captured image I_λ1 is higher than that of the captured image I_λ2. On the other hand, 10 percent may be, for example, used as a binarization threshold.

The calculation section 62 detects the skin region representing the viewer's skin based on the binarized skin image I_skin.

That is, for example, the calculation section 62 detects, as a skin region, those regions with percentage points equal to or higher than the binarization threshold of all the regions making up the binarized skin image I_skin.

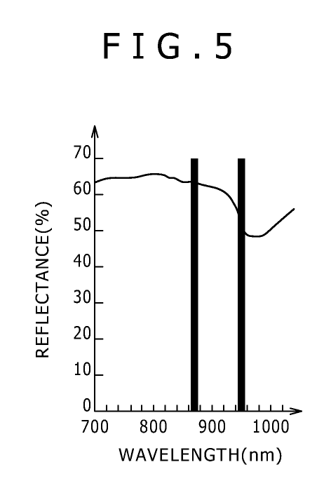

It should be noted that the principle behind the detection of the skin region of the viewer as described above will be described later with reference to FIG. 5.

Here, in order to calculate the difference image I_diff, the luminance level Y(off) of the captured image I_off is used to eliminate the impact of external light other than illumination light of the LEDs 42a and 42b, thus providing improved accuracy in skin detection.

It should be noted that if there is only a slight impact of external light, the difference image I_diff may be calculated without acquiring the captured image I_off.

On the other hand, if a visible light cutting filter is provided on the front surface of the lens of the camera 43 to cut off (block) visible light, it is possible to remove impact of visible light as external light, thus providing improved accuracy in skin detection.

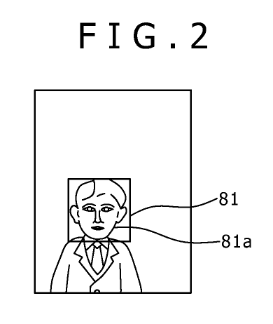

The calculation section 62 calculates, from a smallest rectangular region 81 including a skin region 81a as shown, for example, in FIG. 2, viewpoint information of the viewer as a calculation region including at least the detected skin region.

That is, for example, the calculation section 62 calculates a feature quantity representing a feature of the viewer's face from the rectangular region 81. Then, the calculation section 62 refers to a memory or other storage section (not shown) using the calculated feature quantity, thus calculating viewpoint information and supplying this information to the display control section 63. Here, among specific examples of feature quantities representing the facial feature are the shape of the face and the shape of part of the face.

It should be noted that we assume that a plurality of feature quantities are stored in the memory or other storage section (not shown) in advance, each correlated with one of different pieces of viewpoint information. Therefore, the calculation section 62 performs pattern matching to compare the calculated feature quantity against the plurality of feature quantities stored, for example, in the memory or other storage section not shown.

Then, the calculation section 62 determines the feature quantity that is most analogous to that calculated from the rectangular region 81 by pattern matching, reading the viewpoint information related to the determined feature quantity and supplying the viewpoint information to the display control section 63.

Here, a feature quantity to be stored in the memory may be calculated, for example, in consideration of variations in facial feature from one person to another and made available in advance at the time of shipment of the image processor 21.

That is, for example, a feature quantity to be stored in the memory is calculated from a plurality of captured images acquired by capturing images of faces of different persons in consideration of variations in facial feature from one person to another. Then, the calculated feature quantity is stored in advance in the memory not shown in correlation with viewpoint information including the positions of the right and left eyes of the person at the time of image capture. In this case, it is preferred that the position of the camera 43, its angle of view, its image capture direction and so on should be identical to those of the camera which captured the images of the faces of different persons that were used to calculate the feature quantity stored in advance in the memory not shown.

Alternatively, a feature quantity to be stored in the memory may be calculated, for example, when the power for the image processor 21 is turned on. That is, for example, an image of the viewer may be captured by the camera 43 when the power for the image processor 21 is turned on so that a feature quantity is calculated from the captured image acquired from the image capture. In this case, the calculated feature quantity is similarly stored in advance in the memory not shown in correlation with viewpoint information including the positions of the right and left eyes of the person at the time of image capture.

Incidentally, the rectangular region 81 is a region in the captured image I_λ1. However, the rectangular region 81 may be a region in any captured image so long as the viewer appears in the image.

Further, if the calculation section 62 detects a plurality of skin regions, a smallest rectangular region including the plurality of detected skin regions may be used as the rectangular region 81. Alternatively, for example, a rectangular region including at least the largest skin region in terms of area of the plurality of skin regions or a rectangular region including at least the skin region closest to the center of the image of the plurality of skin regions may be used as the rectangular region 81. It should be noted that the shape of the calculation region used for calculation of viewpoint information is not limited to being rectangular.

The display control section 63 changes the display positions of the two-dimensional images for left and right eyes to be displayed on the LCD 22 based on the viewpoint information from the calculation section 62, thus displaying the two-dimensional images for left and right eyes at the changed display positions on the LCD 22. It should be noted that the process performed by the display control section 63 to change the display positions will be described in detail with reference to FIGS. 3 and 4.

### [Example of Changing Display Positions of Two-Dimensional Images for Left and Right Eyes]

Next, FIG. 3 illustrates an example of the case in which the display control section 63 changes the display positions of the two-dimensional images for left and right eyes to be displayed on the LCD 22 according to viewpoint information of the viewer.

For example, the display control section 63 determines a left eye position 101L and right eye position 101R relative to the LCD 22 as illustrated in FIG. 3 based on the viewpoint information from the calculation section 62. Then, the display control section 63 divides all the regions making up the two-dimensional image for left eye into four thin rectangular regions (hereinafter referred to as the thin rectangular regions for left eye) based on the determination result, thus displaying the image on the LCD 22.

More specifically, for example, the display control section 63 displays the four thin rectangular regions for left eye acquired by dividing the two-dimensional image for left eye in regions 4 to 7, 12 to 15, 20 to 23 and 28 to 31 of all regions from 0 to 31 making up the LCD 22.

It should be noted that the letter “L” is added to the regions 4 to 7, 12 to 15, 20 to 23 and 28 to 31 in FIG. 3 to show that the two-dimensional image for left eye is displayed in these regions.

Further, for example, the display control section 63 divides all the regions making up the two-dimensional image for right eye into four thin rectangular regions (hereinafter referred to as the thin rectangular regions for right eye), thus displaying the image on the LCD 22.

More specifically, for example, the display control section 63 displays the four thin rectangular regions for right eye acquired by dividing the two-dimensional image for right eye in the regions 0 to 3, 8 to 11, 16 to 19 and 24 to 27 of all the regions from 0 to 31 making up the LCD 22.

It should be noted that the letter “R” is added to the regions 0 to 3, 8 to 11, 16 to 19 and 24 to 27 in FIG. 3 to show that the two-dimensional image for right eye is displayed in these regions.

Further, in the present embodiment, a slit is provided on the front surface of the parallax barrier 22a to permit passage of light in each of the regions 0, 1, 6, 7, 12, 13, 18, 19, 24, 25, 30 and 31 of all the regions from 0 to 31 of the LCD 22.

Next, FIG. 4 illustrates another example of the case in which the display positions of the two-dimensional images for left and right eyes to be displayed on the LCD 22 are changed according to a change in viewpoint information of the viewer.

The display control section 63 controls the LCD 22 to change the display positions of the two-dimensional images for left and right eyes, for example, if the positions of the left and right eyes included in the viewpoint information from the calculation section 62 change.

That is, if the left eye position 101L changes to a position 102L, and the right eye position 101R to a position 102R as illustrated, for example, in FIG. 4, the display control section 63 determines the left eye position 102L and right eye position 102R relative to the LCD 22 based on the viewpoint information from the calculation section 62. Then, the display control section 63 changes the display positions of the two-dimensional images for left and right eyes based on the determination result, thus displaying the two-dimensional images for left and right eyes on the LCD 22.

More specifically, for example, the display control section 63 displays the four thin rectangular regions for left eye acquired by dividing the two-dimensional image for left eye in the regions 2 to 5, 10 to 13, 18 to 21 and 26 to 29 of all the regions from 0 to 31 making up the LCD 22.

It should be noted that the letter “L” is added to the regions 2 to 5, 10 to 13, 18 to 21 and 26 to 29 in FIG. 4 to show that the two-dimensional image for left eye is displayed in these regions.

Further, for example, the display control section 63 displays the four thin rectangular regions for right eye acquired by dividing the two-dimensional image for right eye in the regions 0 to 1, 6 to 9, 14 to 17, 22 to 25 and 30 to 31 of all the regions from 0 to 31 making up the LCD 22.

It should be noted that the letter “R” is added to the regions 0 to 1, 6 to 9, 14 to 17, 22 to 25 and 30 to 31 in FIG. 4 to show that the two-dimensional image for right eye is displayed in these regions.

The display control section 63 changes the display positions of the two-dimensional images for right and left eyes based, for example, on the right and left eye positions of the viewer as illustrated in FIG. 4.

This ensures that the two-dimensional image for left eye is visually recognized only by the left eye located at the position 102L, and that the two-dimensional image for right eye is visually recognized only by the right eye located at the position 102R. As a result, the viewer can visually recognize the image on the LCD 22 as a stereoscopic image. It should be noted that the same holds true when a lenticular lens is used.

In addition to the above, for example, the display control section 63 may control the parallax barrier 22a to allow the viewer to visually recognize an image as a stereoscopic image.

That is, for example, the display control section 63 may control the parallax barrier 22a to change the positions of the slits adapted to permit passage of light instead of or as well as changing the display positions of the two-dimensional images for right and left eyes.

In this case, the parallax barrier 22a may include, for example, switching liquid crystal that can change the slit positions under control of the display control section 63.

Referring back to FIG. 1, the LED 42a lights up or goes out under control of the light emission control section 61. That is, the LED 42a emits or stops emitting light at the first wavelength λ1 (e.g., infrared light at the first wavelength λ1) under control of the light emission control section 61.

The LED 42b lights up or goes out under control of the light emission control section 61. That is, the LED 42b emits or stops emitting light at the second wavelength λ2 longer than the first wavelength λ1 (e.g., infrared light at the second wavelength λ2) under control of the light emission control section 61.

It should be noted that the LEDs 42a and 42b emit light to such an extent that the light therefrom is emitted onto the viewer.

On the other hand, the combination of the wavelengths λ1 and λ2 (λ1, λ2) is determined in advance based, for example, on the spectral reflection characteristic on human skin.

Next, FIG. 5 illustrates spectral reflection characteristic on human skin.

It should be noted that the spectral reflection characteristic has generality irrespective of the difference in human skin tone (difference in race) or skin condition (e.g., suntan).

In FIG. 5, the horizontal axis represents the wavelength of light emitted onto human skin, and the vertical axis the reflectance of light emitted onto human skin.

It is known that the reflectance of light emitted onto human skin peaks at about 800 [nm], declines steeply from about 900 [nm], reaches its minimum at about 1000 [nm] and increases again.

More specifically, for example, the reflectance of reflected light acquired by emitting infrared light at 870 [nm] onto human skin is about 63% as illustrated, for example, in FIG. 5. On the other hand, the reflectance of reflected light acquired by emitting infrared light at 950 [nm] is about 50%

This is specific to human skin. In the case of an object other than human skin (e.g., clothing), the reflectance changes more gently from about 800 to 1000 [nm]. Frequently, on the other hand, the higher the frequency, the larger the reflectance becomes little by little.

In the present embodiment, the combination (λ1, λ2) is (870, 950). This combination provides a larger reflectance when light at the wavelength λ1 is emitted onto human skin than when light at the wavelength λ2 is emitted onto human skin.

Therefore, the luminance level of the skin region in the captured image I_λ1 is relatively large. On the other hand, the luminance level of the skin region in the captured image I_λ2 is relatively small.

Therefore, the luminance level of the skin region in the difference image I_diff (={I_λ1−I_λ2)/(I_λ1−I_off)}×100) is a relatively large positive value α1.

Further, the combination (λ1, λ2)=(870, 950) provides almost the same reflectance when light at the wavelength λ1 is emitted onto an object other than human skin as when light at the wavelength λ2 is emitted onto that object.

Therefore, the luminance level of the non-skin region in the difference image I_diff (={(I_λ1−I_λ2)/(I_λ1−I_off)}×100) is a relatively small positive or negative value β1.

Therefore, the skin region is detected by binarizing the difference image I_diff with a predetermined binarization threshold (e.g., threshold smaller than α1 and larger than β1).

Here, the combination (λ1, λ2) is not limited to (λ1, λ2)=(870, 950) but may be any combination (λ1, λ2) so long as the difference in reflectance is sufficiently large.

It should be noted that it has been found from experiments conducted by the present inventor in advance that, in general, the wavelength λ1 should preferably be somewhere between 640 [nm] and 1000 [nm], and the wavelength λ2 somewhere between 900 [nm] and 1100 [nm] in order to ensure accuracy in skin detection.

However, if the wavelength λ1 falls within the visible range, the viewer feels that the light is too bright, and the color tone of the image viewed by the viewer on the display is affected. Therefore, the wavelength λ1 should preferably be 800 [nm] or higher in the invisible range.

That is, for example, the wavelength λ1 should preferably be somewhere between 800 [nm] and 900 [nm] in the invisible range, and the wavelength λ2 equal to or higher than 900 [nm] in the invisible range to the extent of falling within the above ranges.

Referring back to FIG. 1, the camera 43 includes, for example, a lens or CMOS (complementary metal oxide semiconductor) sensor and captures an image of the subject in response to a frame synchronizing signal. Further, the camera 43 supplies a frame synchronizing signal to the light emission control section 61.

More specifically, for example, the camera 43 receives, with a photoreception element provided in the CMOS sensor or other part of the camera, reflected light of the light at the wavelength λ1 emitted by the LED 42a onto the subject. Then, the camera 43 supplies the captured image I_λ1, acquired by converting the received reflected light into an electric signal, to the calculation section 62.

Further, for example, the camera 43 receives, with the photoreception element provided in the CMOS sensor or other part of the camera, reflected light of the light at the wavelength λ2 emitted by the LED 42b onto the subject. Then, the camera 43 supplies the captured image I_λ2, acquired by converting the received reflected light into an electric signal, to the calculation section 62.

Still further, for example, the camera 43 receives, with the photoreception element provided in the CMOS sensor or other part of the camera, reflected light from the subject with no light emitted from the LED 42a or 42b onto the subject. Then, the camera 43 supplies the captured image I_off, acquired by converting the received reflected light into an electric signal, to the calculation section 62.

### [Description of Operation of Image Processor 21]

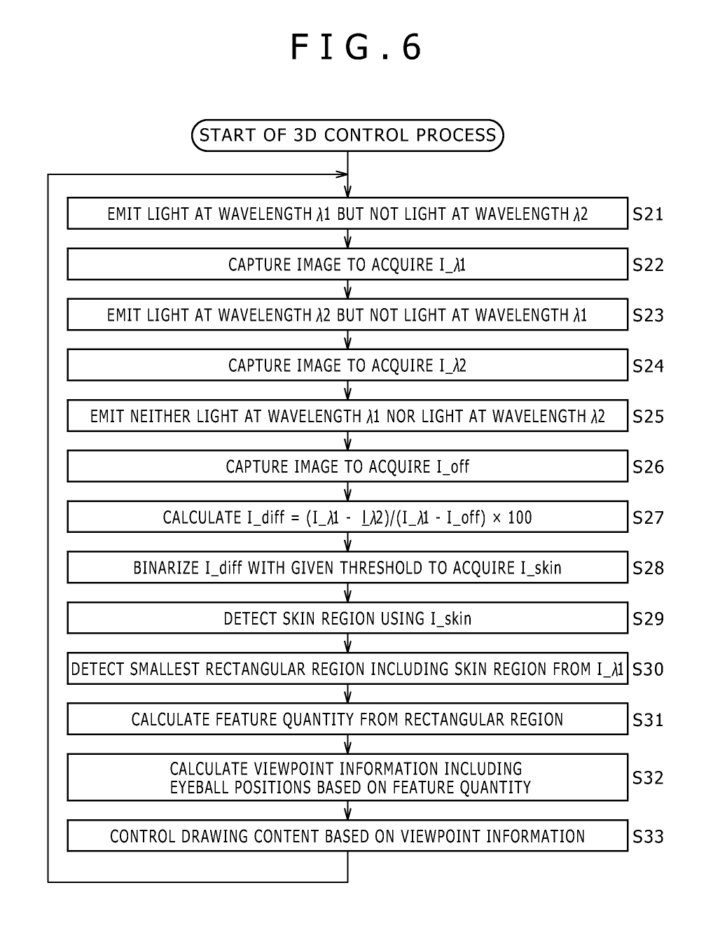

A description will be given next of the 3D control process performed by the image processor 21 with reference to the flowchart shown in FIG. 6.

This 3D control process begins, for example, when the power for the image processor 21 is turned on as a result of manipulation of an operation switch or other switch (not shown) provided on the image processor 21.

In step S21, the light emission control section 61 lights up the LED 42a in response to a frame synchronizing signal from the camera 43 when the camera 43 captures an image (process in step S22). This allows the LED 42a to emit light at the wavelength λ1 onto the subject while the camera 43 captures an image. It should be noted that the LED 42b is unlit.

In step S22, the camera 43 begins to capture an image of the subject onto which the light from the LED 42a is emitted, supplying the resultant captured image I_λ1 to the calculation section 62.

In step S23, the light emission control section 61 extinguishes the LED 42a in response to a frame synchronizing signal from the camera 43 when the camera 43 terminates its image capture in step S22.

Further, the light emission control section 61 lights up the LED 42b in response to a frame synchronizing signal from the camera 43 when the camera 43 captures a next image (process in step S24). This allows the LED 42b to emit light at the wavelength λ2 onto the subject while the camera 43 captures a next image. It should be noted that the LED 42a is unlit.

In step S24, the camera 43 begins to capture an image of the subject onto which the light from the LED 42b is emitted, supplying the resultant captured image I_λ2 to the calculation section 62.

In step S25, the light emission control section 61 extinguishes the LED 42b in response to a frame synchronizing signal from the camera 43 when the camera 43 terminates its image capture in step S24. As a result, both the LEDs 42a and 42b are unlit.

In step S26, the camera 43 begins to capture an image with both the LEDs 42a and 42b unlit, supplying the resultant captured image I_off to the calculation section 62.

In step S27, the calculation section 62 calculates the difference image I_diff (={(I_λ1−I_λ2)/(I_λ1−I_off)}×100) based on the captured images I_λ1, I_λ2 and I_off from the camera 43.

In step S28, the calculation section 62 binarizes the difference image I_diff with a predetermined binarization threshold, thus calculating the binarized skin image I_skin.

In step S29, the calculation section 62 detects, for example, the skin region 81a based on the calculated binarized skin image I_skin.

In step S30, the calculation section 62 detects, for example, the smallest rectangular region 81 including the skin region 81a from the captured image I_λ1.

In step S31, the calculation section 62 calculates, from the detected rectangular region 81, a feature quantity representing the feature of the viewer's face represented by the skin region 81a.

In step S32, the calculation section 62 calculates, for example, viewpoint information including the positions of the viewer's right and left eyes from the calculated feature quantity, supplying the viewpoint information to the display control section 63.

That is, for example, the calculation section 62 performs pattern matching using the calculated feature quantity by referring to the memory (not shown) provided in the image processor 21, thus calculating viewpoint information and supplying the information to the display control section 63.

It should be noted that viewpoint information may be calculated by a method other than pattern matching. That is, for example, the calculation section 62 may calculate viewpoint information based on the fact that human eyes are roughly horizontally symmetrical in a human face, and that each of the eyes is located about 30 mm to the left or right from the center of the face (position on the line segment symmetrically dividing the face).

More specifically, for example, the calculation section 62 may detect the center of the face (e.g., center of gravity of the face) as a position of the viewer's face in the captured image from the rectangular region 81, thus calculating the positions of the viewer's left and right eyes in the captured image from the detected face position as viewpoint information.

Here, the space from the center of the face to the right eye and that from the center of the face to the left eye in the captured image vary depending on a distance D between the camera 43 and viewer. Therefore, the calculation section 62 calculates, as viewpoint information, the positions, each to the left or right from the detected face position at a distance appropriate to the distance D between the camera 43 and viewer.

If viewpoint information is calculated by taking advantage of the above fact, the face position is detected, for example, from the skin region in the captured image, thus estimating the positions of the left and right eyes in the captured image based on the detected face position. Then, the estimated positions of the left and right eyes in the captured image are calculated as viewpoint information.

In this case, therefore, the process is simpler than finding viewpoint information by pattern matching, thus taking only a short time to calculate viewpoint information. This provides excellent responsiveness, for example, even in the event of a movement of the viewer. Further, it is not necessary to use a powerful DSP or CPU (Central Processing Unit) to calculate viewpoint information, thus keeping manufacturing cost low.

It should be noted that the calculation section 62 takes advantage of the fact that the shorter the distance between the LED 42a and viewer, the higher the luminance level of the skin region 81a (skin region free from the impact of external light) as a result of light emission from the LED 42a, thus approximating the distance between the camera 43 and viewer. In this case, we assume that the camera 43 is arranged close to the LED 42a.

Alternatively, the calculation section 62 may use the LED 42b rather than the LED 42a and take advantage of the fact that the shorter the distance between the LED 42b and viewer, the higher the luminance level of the skin region 81a (skin region free from the impact of external light) as a result of light emission from the LED 42b, thus approximating the distance between the camera 43 and viewer. In this case, we assume that the camera 43 is arranged close to the LED 42b.

Therefore, the calculation section 62 can detect the position of the viewer's face from the skin region 81a in the rectangular region 81, thus calculating, as viewpoint information, the positions, each at a distance appropriate to the distance D, found from the luminance level of the skin region 81a, from the detected face position.

Further, if the display screen is small as in a portable device, the distance D from the display to the viewer's face remains within a certain range. Therefore, the calculation of the distance between the camera 43 and viewer may be omitted.

In this case, the distance D from the display to the viewer is a predetermined distance (e.g., a median of a certain range). The positions, each at a distance appropriate to the distance D from the detected face position, are calculated as viewpoint information.

In step S33, the display control section 63 changes the display positions of the two-dimensional images for left and right eyes to be displayed on the LCD 22 based on the viewpoint information from the calculation section 62, thus displaying the two-dimensional images for left and right eyes at the changed display positions on the LCD 22.

That is, for example, the display control section 63 calculates the display positions of the two-dimensional images for left and right eyes to be displayed on the LCD 22 based on the viewpoint information from the calculation section 62. Then, the display control section 63 changes the display positions of the two-dimensional images for left and right eyes to be displayed on the LCD 22 to those calculated based on the viewpoint information, thus displaying the two-dimensional images for left and right eyes at the changed display positions on the LCD 22.

Alternatively, the display control section 63 may have a built-in memory not shown, thus storing, in advance, the display positions of the two-dimensional images for left and right eyes to be displayed on the LCD 22 in correlation with a piece of viewpoint information. In this case, the display control section 63 reads, based on the viewpoint information from the calculation section 62, the display positions correlated with that viewpoint information (data representing the display positions) from the built-in memory.

Then, the display control section 63 changes the display positions of the two-dimensional images for left and right eyes to be displayed on the LCD 22 to those read from the built-in memory according to the viewpoint information, thus displaying the two-dimensional images for left and right eyes at the changed display positions on the LCD 22.

Then, the process returns to step S21, and the same processes are repeated thereafter. It should be noted that this 3D control process is terminated, for example, when the power for the image processor 21 is turned off.

As described above, the 3D control process determines the two-dimensional images for left and right eyes to be displayed in respective regions of the LCD 22 according to viewpoint information of the viewer (e.g., positions of the viewer's right and left eyes).

Therefore, the 3D control process allows visual recognition of an image on the LCD 22 as a stereoscopic image irrespective of the viewer's viewpoint.

Further, the 3D control process takes advantage of the spectral reflection characteristic of a human as shown in FIG. 5 to allow detection of the skin region of the viewer by emitting light beams, one at the wavelength λ1 and another at the wavelength λ2.

As a result, the 3D control process makes it possible to detect the skin region with high accuracy irrespective of the brightness of the environment in which the image processor 21 is used.

This ensures highly accurate detection of the skin region in the captured image, for example, even when the image processor 21 is used in a dark location. Further, if invisible light is used as light at the first and second wavelengths λ1 and λ2, the visual recognition of the image on the LCD 22 remains unaffected.

Further, the 3D control process detects, for example, the rectangular region 81 including the viewer's skin region, thus calculating viewpoint information by using the detected rectangular region 81 as a region of interest.

Therefore, it is possible to calculate viewpoint information at a dark location where it is difficult to calculate viewpoint information from an image captured with ordinary visible light. Further, for example, it is possible to reduce the burden on the DSP, CPU or other processor handling the 3D control process as compared to the calculation of viewpoint information using all the regions of the captured image as regions of interest.

More specifically, for example, the rectangular region 81 is equal to or less than 1/10 of all the regions in the captured image in the case as shown in FIG. 2. Therefore, using the rectangular region 81 as a region of interest contributes to a reduction of the amount of calculations for calculating viewpoint information to 1/10 or less as compared to using all the regions of the captured image as regions of interest.

For example, therefore, it is not necessary to incorporate an expensive DSP to provide improved processing capability. As a result, an inexpensive DSP can be used instead, thus keeping the manufacturing cost of the image processor 21 low.

Further, the amount of calculations for calculating viewpoint information can be reduced. This makes it possible to use a portable product with limited processing and other capabilities because of downsizing (e.g., carryable portable television receiver, portable gaming machine, portable optical disc player, mobile phone) as the image processor 21.

It should be noted that if the image processor 21 is used as a television receiver, portable gaming machine, portable optical disc player or mobile phone, the image processor 21 may include the LCD 22 and parallax barrier 22a.

Further, in addition to the portable products, an ordinary television receiver, i.e., a non-downsized receiver, for example, can be used as the image processor 21. In addition to the above, the image processor 21 is applicable, for example, to a player adapted to play content such as moving or still image made up of a plurality of images or a player/recorder adapted to record and play content.

That is, the present disclosure is applicable to any display device adapted to stereoscopically display an image or a display controller adapted to allow an image to be stereoscopically displayed on a display or other device.

Incidentally, in the present embodiment, the calculation section 62 calculates, for example, a feature quantity representing the shape of the viewer's face or the shape of part thereof from the smallest rectangular region 81 including the entire skin region 81a in the captured image as illustrated in FIG. 2.

Alternatively, however, the calculation section 62 may calculate, for example, a feature quantity representing a feature of the viewer's eyes, thus calculating viewpoint information of the viewer based on the calculated feature quantity by referring to a memory not shown. It should be noted that among feature quantities representing a feature of eyes is, more specifically, that representing the shapes of the eyes, for example.

In this case, for example, eye regions representing the viewer's eyes rather than the skin region 81a are detected, thus calculating a feature quantity of the viewer's eyes from the smallest rectangular region including all the eye regions in the captured image as a calculation region including at least the eye regions. On the other hand, the feature quantity representing the feature of the viewer's eyes is stored in advance in the memory or other storage section not shown.

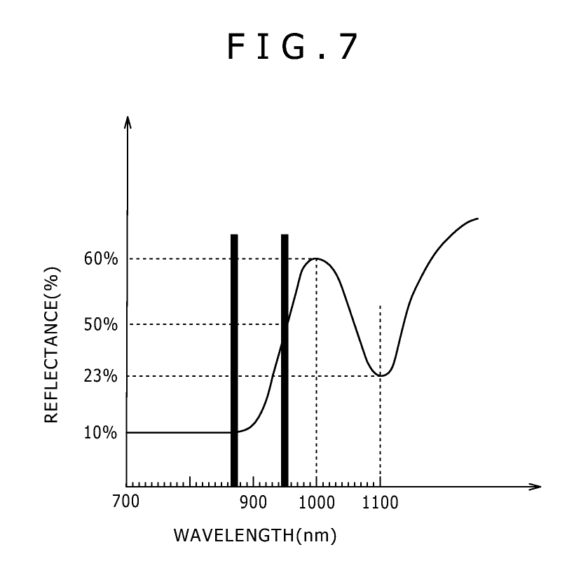

A description will be given next of an example of the case in which the calculation section 62 detects the eye regions of the viewer with reference to FIG. 7.

### [Spectral Reflection Characteristic on Human Eyes]

FIG. 7 illustrates spectral reflection characteristic on human eyes.

In FIG. 7, the horizontal axis represents the wavelength of light emitted onto human eyes, and the vertical axis the reflectance of light emitted onto human eyes.

It is known that the reflectance of light emitted onto human eyes increases from about 900 [nm] to about 1000 [nm].

Therefore, the luminance level of the eye regions in the captured image I_λ1 is a relatively small value, and the luminance level of the eye regions in the captured image I_λ2 is a relatively large value.

For this reason, the luminance level of the eye regions in the difference image I_diff is a relatively large negative value α2.

By taking advantage of the above, it is possible to calculate a binarized skin image I_eye from the difference image I_diff using a threshold adapted to detect the eye regions, thus detecting the eye regions from the calculated binarized skin image I_eye.

If the eye regions are successfully detected, the positions thereof (e.g., centers of gravity of the eye regions) match the positions of the eyes in the captured image. This ensures higher accuracy in calculation of viewpoint information than when viewpoint information is calculated by pattern matching or from the face position. Further, the amount of calculations for calculating viewpoint information can be reduced to an extremely small level, thus providing faster processing and contributing to reduced cost thanks to the use of an inexpensive DSP.

It should be noted that the luminance level of the skin region in the difference image I_diff is the relatively large positive value α1. Therefore, not only a skin region but also eye regions may be detected from the difference image I_diff using a threshold adapted to detect a skin region together with that adapted to detect eye regions.

In this case, the calculation section 62 calculates, for example, a feature quantity of the viewer's face or eyes from the smallest rectangular region including both the skin and eye regions.

### <2. Modification Example>

The present embodiment has been described assuming that there is one viewer viewing the image on the LCD 22 for simplification of the description. However, the present technology is also applicable when there are two or more viewers thanks to a small amount of calculations for calculating viewpoint information.

That is, for example, if there are two or more viewers, the calculation section 62 calculates viewpoint information of each viewer using the smallest rectangular region including all the skin regions of the plurality of viewers as a region of interest. It should be noted that if there are two or more viewers, the calculation section 62 may calculate viewpoint information of each viewer using the smallest rectangular region including all the eye regions of the plurality of viewers as regions of interest.

Then, the calculation section 62 may supply the median or mean of the right eye positions included in the plurality of pieces of calculated viewpoint information to the display control section 63 as a final right eye position. Further, the calculation section 62 may calculate a final left eye position in the same manner and supply the position to the display control section 63.

This allows the display control section 63 to control the LCD 22 and other sections to ensure that an image is visually recognized to a certain extent as a stereoscopic image by any of the plurality of viewers.

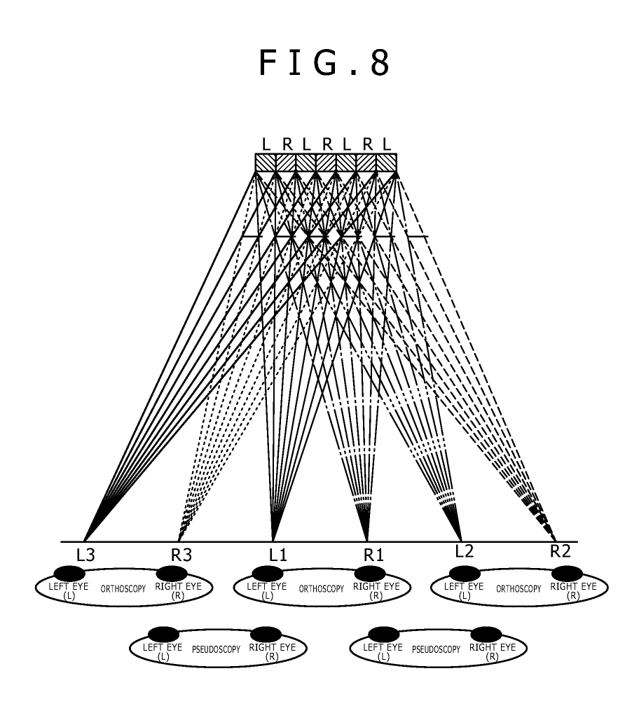

In the parallax barrier approach using the parallax barrier 22a, on the other hand, there are two or more viewpoint positions spaced at given intervals as illustrated in FIG. 8 where the viewer can stereoscopically recognize an image without causing pseudoscopy, i.e., viewpoint positions where the viewer can have an orthoscopic view of the image. Only three such viewpoint positions are shown in FIG. 8. Actually, however, there are two or more such viewpoint positions both to the left and right of these viewpoint positions. Further, there are two or more viewpoint positions where the viewer ends up having a pseudoscopic view of the image. Each of these viewpoint positions is located between the viewpoint positions where the viewer can correctly stereoscopically recognize an image.

That is, when there are two or more viewers, it is not always possible to control the display of an image in such a manner that the image appears stereoscopic depending on the positional relationship between the viewers even if the image is controlled.

Therefore, the calculation section 62 may control a display mechanism (e.g., LCD 22 and parallax barrier 22a) according to calculated viewpoint information of each of the plurality of viewers only when the calculation section 62 acknowledges that the display mechanism can be controlled in such a manner that the positions of all the plurality of viewers are near the viewpoint positions where an image can be stereoscopically recognized.

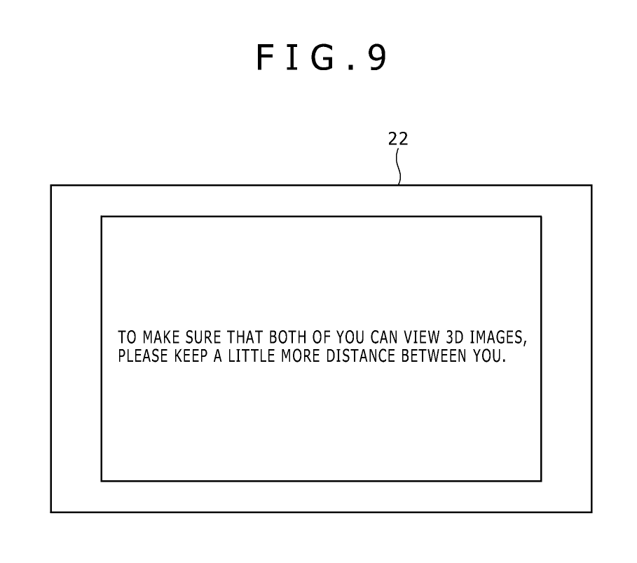

Alternatively, a message saying “To make sure that both of you can view 3D images, please keep a little more distance between you” may be displayed on the display screen of the LCD 22 as shown, for example, in FIG. 9 to prompt the plurality of viewers to change their relative distances so that each of all the viewers can move to one of the viewpoint positions where an image can be stereoscopically recognized without causing pseudoscopy.

In addition to the above, for example, a message may be displayed on the display screen of the LCD 22, for example, to prompt a specific one of the plurality of viewers to move to the left or right.

Still alternatively, a speaker, for example, may be provided in the image processor 21 to prompt the viewers to move by voice rather than by displaying a message on the LCD 22.

Still alternatively, the display control section 63 may control the display mechanism to ensure that the viewer, to whom the skin region closest to the center of the display screen of the LCD 22 of all the plurality of skin regions is assigned, can view an image stereoscopically.

That is, the viewer, to whom the skin region closest to the center of the display screen of the LCD 22 is assigned, is primarily the one who continues to watch the image stereoscopically. Other viewers often simply peep into the LCD 22 for a short period of time. This can simplify the viewpoint information calculation process.

In this case, if viewers other than the primary one continue to stay at viewpoint positions where pseudoscopy occurs rather than orthoscopy for more than a predetermined period of time, the display control section 63 may stop displaying an image that appears stereoscopic and, instead display a two-dimensional image.

Still alternatively, for example, the display control section 63 may display an image according to the viewpoint information of the viewer most likely to be adversely affected by pseudoscopy of all the plurality of viewers.

That is, for example, the more infant the viewer, in which case the viewer is in general more likely to be adversely affected by pseudoscopy, the more frequent it is for him or her to view content at a short distance from the LCD 22. Therefore, the display control section 63 controls the LCD 22 and other sections, for example, using the viewpoint information in which the positions of the right and left eyes are closest to the LCD 22 of all the pieces of viewpoint information of the plurality of viewers. It should be noted that, in this case, the calculation section 62 calculates viewpoint information for each of the plurality of viewers and supplies the viewpoint information to the display control section 63.

In addition to the above, the calculation section 62 may, for example, calculate viewpoint information of a viewer (e.g., infant) viewing the LCD 22 from a short distance based on the skin region detected close to the LCD 22, thus supplying the viewpoint information to the display control section 63. In this case, the display control section 63 controls the LCD 22 and other sections using the viewpoint information from the calculation section 62.

It should be noted that the skin region (e.g., skin region of an infant viewing the LCD 22 from a short distance) detected close to the LCD 22 is determined by the calculation section 62, for example, according to the magnitude of luminance of illumination light from at least one of the LEDs 42a and 42b.

Further, the calculation section 62 may determine whether or not the viewer is an infant by taking advantage of the fact that the more infant the viewer, the relatively closer the eyes are to the chin in the face. More specifically, for example, the calculation section 62 detects the facial region by skin detection and the eye regions by eye detection, thus allowing to determine whether or not the viewer is an infant based on the position of the facial region relative to the positions of the eye regions (e.g., center of gravity of the facial region relative to those of the eye regions). In this case, the calculation section 62 calculates viewpoint information based on the skin region of the viewer determined to be an infant, thus supplying the viewpoint information to the display control section 63.

In the present embodiment, the parallax barrier 22a is provided on the front surface of the LCD 22. However, where the parallax barrier 22a is provided is not limited thereto. Instead, the parallax barrier 22a may be provided between the LCD 22 and backlight of the LCD 22.

It should be noted that the present technology may have the following configurations.

(1) An image processor including:

a first emission section configured to emit light at a first wavelength to a subject;

a second emission section configured to emit light at a second wavelength longer than the first wavelength to the subject;

an imaging section configured to capture an image of the subject;

a detection section configured to detect a body region representing at least one of the skin and eyes of the subject based on a first captured image acquired by image capture at the time of emission of the light at the first wavelength and a second captured image acquired by image capture at the time of emission of the light at the second wavelength;

a calculation section configured to calculate viewpoint information relating to the viewpoint of the subject from a calculation region including at least the detected body region; and
a display control section configured to control a display mechanism adapted to allow the subject to visually recognize an image as a stereoscopic image according to the viewpoint information.

(2) The image processor of feature (1), in which

the calculation section includes:
a feature quantity calculation section configured to calculate, from the calculation region, a feature quantity representing the feature of a predetermined body region of all the body regions of the subject; and
a viewpoint information calculation section configured to calculate the viewpoint information from the calculated feature quantity by referring to a storage section adapted to store, in advance, candidates for the viewpoint information in correlation with one of the feature quantities that are different from one another.

(3) The image processor of feature (2), in which

the feature quantity calculation section calculates a feature quantity representing a feature of the subject's face from the calculation region including at least the body region representing the subject's skin.

(4) The image processor of feature (2), in which

the feature quantity calculation section calculates a feature quantity representing a feature of the subject's eyes from the calculation region including at least the body region representing the subject's eyes.

(5) The image processor of any one of features (1) to (4), in which

the calculation section calculates, from the calculation region, the viewpoint information including at least one of the direction of the subject's line of sight, the position of the subject's right eye, the position of the subject's left eye and the position of the subject's face.

(6) The image processor of any one of features (1) to (4), in which

the display control section controls the display mechanism to display a two-dimensional image for right eye at a position where the image can be visually recognized only by the right eye from the subject's line of sight and a two-dimensional image for left eye at a position where the image can be visually recognized only by the left eye from the subject's line of sight.

(7) The image processor of any one of features (1) to (4), in which

the display control section controls the display mechanism to separate a two-dimensional image for right eye that can be visually recognized only by the right eye from the subject's line of sight and a two-dimensional image for left eye that can be visually recognized only by the left eye from the subject's line of sight from a display screen operable to display the two-dimensional images for right and left eyes.

(8) The image processor of feature (7), in which

the display mechanism is a parallax barrier or lenticular lens.

(9) The image processor of any one of features (1) to (4), in which

the first wavelength λ1 is equal to or greater than 640 nm and equal to or smaller than 1000 nm, and the second wavelength λ2 is equal to or greater than 900 nm and equal to or smaller than 1100 nm.

(10) The image processor of feature (9), in which

the first emission section emits invisible light at the first wavelength λ1, and the second emission section emits invisible light at the second wavelength λ2.

(11) The image processor of any one of features (1) to (4), in which

the imaging section has a visible light cutting filter operable to block visible light falling on the imaging section.

(12) An image processing method of an image processor including a first emission section configured to emit light at a first wavelength to a subject, a second emission section configured to emit light at a second wavelength longer than the first wavelength to the subject, and an imaging section configured to capture an image of the subject, the image processing method including:

detecting a body region representing at least one of the skin and eyes of the subject based on a first captured image acquired by image capture at the time of emission of the light at the first wavelength and a second captured image acquired by image capture at the time of emission of the light at the second wavelength;

calculating viewpoint information relating to the viewpoint of the subject from a calculation region including at least the detected body region; and

controlling a display mechanism adapted to allow the subject to visually recognize an image as a stereoscopic image according to the viewpoint information.

(13) A program allowing a computer of an image processor to serve as a detection section, calculation section and display control section, the image processor including:

a first emission section configured to emit light at a first wavelength to a subject;

a second emission section configured to emit light at a second wavelength longer than the first wavelength to the subject; and

an imaging section configured to capture an image of the subject, the detection section detecting a body region representing at least one of the skin and eyes of the subject based on a first captured image acquired by image capture at the time of emission of the light at the first wavelength and a second captured image acquired by image capture at the time of emission of the light at the second wavelength, the calculation section calculating viewpoint information relating to the viewpoint of the subject from a calculation region including at least the detected body region, and the display control section controlling a display mechanism adapted to allow the subject to visually recognize an image as a stereoscopic image according to the viewpoint information.

Incidentally, the above series of processes may be performed by hardware or software. If the series of processes are performed by software, the program making up the software is installed from a program recording medium to a computer incorporated in dedicated hardware or a computer such as general-purpose computer capable of performing various functions when installed with various programs.

### [Configuration Example of Computer]

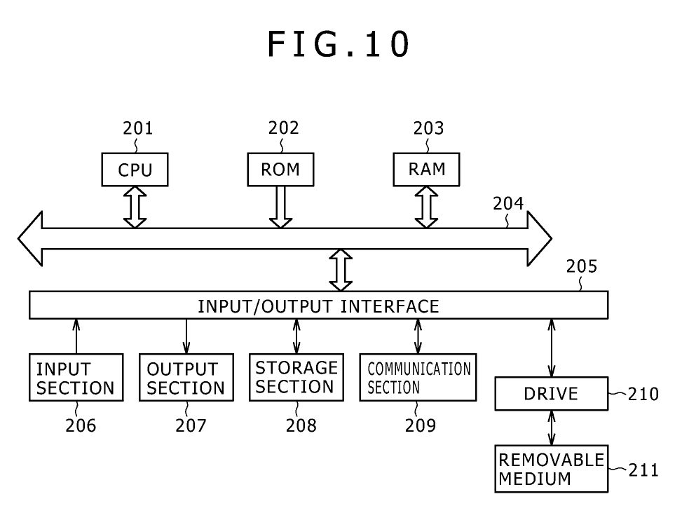

FIG. 10 illustrates a hardware configuration example of a computer operable to execute the above series of processes using a program.

A CPU (Central Processing Unit) 201 performs various processes according to the program stored in a ROM (Read Only Memory) 202 or that stored in a storage section 208. A RAM (Random Access Memory) 203 stores, as appropriate, programs executed by the CPU 201 and data. The CPU 201, ROM 202 and RAM 203 are connected to each other via a bus 204.

An input/output interface 205 is also connected to the CPU 201 via the bus 204. An input section 206 and output section 207 are connected to the input/output interface 205. The input section 206 includes, for example, a keyboard, mouse and microphone. The output section 207 includes, for example, a display and speaker. The CPU 201 performs various processes in response to an instruction fed from the input section 206. Then, the CPU 201 outputs the results of the processes to the output section 207.

The storage section 208 connected to the input/output interface 205 includes, for example, a hard disk to store the programs to be executed by the CPU 201 and various data. A communication section 209 communicates with external equipment via a network such as the Internet or local area network.

Alternatively, a program may be acquired via the communication section 209 and stored in the storage section 208.

A drive 210 connected to the input/output interface 205 drives a removable medium 211 such as magnetic disc, optical disc, magneto-optical disc or semiconductor memory when the removable medium 211 is inserted into the drive 210, thus acquiring the program or data recorded thereon. The acquired program or data is transferred to the storage section 208 as necessary for storage.

A recording medium operable to record (store) the program installed to and rendered executable by the computer includes the removable medium 211, ROM 202 or a hard disk making up the storage section 208 as illustrated in FIG. 10. The removable medium 211 is a package medium made up of a magnetic disc (including a flexible disc), optical disc (including CD-ROM (Compact Disc-Read Only Memory) and DVD (Digital Versatile Disc)), magneto-optical disc (including MD (Mini-Disc)) or semiconductor memory. The ROM 202 temporarily or permanently stores the program. The program is recorded to the recording medium as necessary via the communication section 209, i.e., an interface such as a router or modem, using a wired or wireless communication medium such as a local area network, the Internet or digital satellite broadcasting.

It should be noted that the above series of processes described in the present specification include not only those performed chronologically according to the described sequence but also those that are not necessarily performed chronologically but in parallel or individually.

On the other hand, the embodiments of the present disclosure are not limited to that described above but may be modified in various ways without departing from the scope of the present disclosure.

The present disclosure contains subject matter related to that disclosed in Japanese Priority Patent Application JP 2011-197793 filed in the Japan Patent Office on Sep. 12, 2011, the entire content of which is hereby incorporated by reference.

What is claimed is:

1. An image processor comprising:
a first emission section configured to emit light at a first wavelength to a subject;
a second emission section configured to emit light at a second wavelength longer than the first wavelength to the subject;
an imaging section configured to capture an image of the subject;
a detection section configured to detect a body region representing at least one of the skin and eyes of the subject based on a first captured image acquired by image capture at the time of emission of the light at the first wavelength and a second captured image acquired by image capture at the time of emission of the light at the second wavelength;
a calculation section configured to calculate viewpoint information relating to the viewpoint of the subject from a calculation region including at least the detected body region; and
a display control section configured to control a display mechanism adapted to allow the subject to visually recognize an image as a stereoscopic image according to the viewpoint information.

2. The image processor according to claim 1,
wherein the calculation section includes:
a feature quantity calculation section configured to calculate, from the calculation region, a feature quantity representing the feature of a predetermined body region of all the body regions of the subject; and
a viewpoint information calculation section configured to calculate the viewpoint information from the calculated feature quantity by referring to a storage section adapted to store, in advance, candidates for the viewpoint information in correlation with one of the feature quantities that are different from one another.

3. The image processor according to claim 2,
wherein the feature quantity calculation section calculates a feature quantity representing a feature of the subject's face from the calculation region including at least the body region representing the subject's skin.

4. The image processor according to claim 2,
wherein the feature quantity calculation section calculates a feature quantity representing a feature of the subject's eyes from the calculation region including at least the body region representing the subject's eyes.

5. The image processor according to claim 2,
wherein the calculation section calculates, from the calculation region, the viewpoint information including at least one of the direction of the subject's line of sight, the position of the subject's right eye, the position of the subject's left eye and the position of the subject's face.

6. The image processor according to claim 1,
wherein the display control section controls the display mechanism to display a two-dimensional image for right eye at a position where the image can be visually recognized only by the right eye from the subject's line of sight and a two-dimensional image for left eye at a position where the image can be visually recognized only by the left eye from the subject's line of sight.

7. The image processor according to claim 1,
wherein the display control section controls the display mechanism to separate a two-dimensional image for right eye that can be visually recognized only by the right eye from the subject's line of sight and a two-dimensional image for left eye that can be visually recognized only by the left eye from the subject's line of sight from a display screen operable to display the two-dimensional images for right and left eyes.

8. The image processor according to claim 7,
wherein the display mechanism is a parallax barrier or lenticular lens.

9. The image processor according to claim 1,
wherein the first wavelength λ1 is equal to or greater than 640 nm and equal to or smaller than 1000 nm, and the second wavelength λ2 is equal to or greater than 900 nm and equal to or smaller than 1100 nm.

10. The image processor according to claim 9,
wherein the first emission section emits invisible light at the first wavelength λ1, and the second emission section emits invisible light at the second wavelength λ2.

11. The image processor according to claim 1,
wherein the imaging section has a visible light cutting filter operable to block visible light falling on the imaging section.

12. An image processing method of an image processor including a first emission section configured to emit light at a first wavelength to a subject, a second emission section configured to emit light at a second wavelength longer than the first wavelength to the subject, and an imaging section configured to capture an image of the subject, the image processing method comprising:
detecting a body region representing at least one of the skin and eyes of the subject based on a first captured image acquired by image capture at the time of emission of the light at the first wavelength and a second captured image acquired by image capture at the time of emission of the light at the second wavelength;
calculating viewpoint information relating to the viewpoint of the subject from a calculation region including at least the detected body region; and
controlling a display mechanism adapted to allow the subject to visually recognize an image as a stereoscopic image according to the viewpoint information.

13. A program allowing a computer of an image processor to serve as a detection section, calculation section and display control section, the image processor comprising:
a first emission section configured to emit light at a first wavelength to a subject;
a second emission section configured to emit light at a second wavelength longer than the first wavelength to the subject; and
an imaging section configured to capture an image of the subject, the detection section detecting a body region representing at least one of the skin and eyes of the subject based on a first captured image acquired by image capture at the time of emission of the light at the first wavelength and a second captured image acquired by image capture at the time of emission of the light at the second wavelength, the calculation section calculating viewpoint information relating to the viewpoint of the subject from a calculation region including at least the detected body region, and the display control section controlling a display mechanism adapted to allow the subject to visually recognize an image as a stereoscopic image according to the viewpoint information.
